(19) United States
(12) Patent Application Publication
(10) Pub. No.: US 2005/0206632 A1
(43) Pub. Date: Sep. 22, 2005

(54) Integrated display module

(76) Inventor: Cheng-pang Chien, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/910,431

(22) Filed: Aug. 3, 2004

(30) Foreign Application Priority Data
Mar. 19, 2004 (TW) 93107436

(51) Int. Cl. G09G 5/00

(52) U.S. Cl. 345/204

(57) ABSTRACT

An integrated display module having a register, a microprocessor, a display array, and a drive unit. The register stores required setting values as the integrated display module operates. When the integrated display module begins operating, the microprocessor unit writes an initial value to the register. The drive unit drives the display array according to the initial value.

### BACKGROUND OF THE INVENTION

1. Field of the Invention

The present invention relates to an integrated display module, and in particular to an integrated display module for a liquid crystal display.

2. Description of the Related Art

When compared with conventional CRT displays, liquid crystal displays (LCDs) provide advantages of reduced size, lower power consumption, low radiation, and superior contrast. Additionally, size of LCDs employed in mobile communication devices has decreased continuously, wherein LCD module comprises a horizontal drive chip, vertical drive chip, a timing control chip, a frame memory device, a Gamma chip, power circuit, and other related devices. In a highly integrated display module, data and setting values are transmitted through an MPU (microprocessor unit) interface.

A LCD module of a mobile phone typically comprises two interfaces, an MPU interface and an RGB interface. Generally, an external microprocessor configures the display module through the MPU interface. Static image data is transmitted to the frame storage device through the MPU interface. Dynamic image data is transmitted to the timing control chip through the RBG interface and is then transformed to another data type for displaying images on an LCD panel. The RGB interface is merely used to transmit dynamic image data in 3G mobile phone applications. However, to set system values of the display module, the MPU interface must be used frequently in the process of manually configuring system values, incorrect values are input due to user error. Consequently, the LCD panel cannot correctly display images.

### SUMMARY OF THE INVENTION

Accordingly, an object of the present invention is to provide an integrated display module that ameliorates disadvantages of the related art.

According to the above described object, the present invention provides an integrated display module. The integrated display module comprises a register, a microprocessor, a display array, and a drive unit. The register stores required setting values as the integrated display module operates. When the integrated display module begins operating, the microprocessor unit writes initial values to the register. The drive unit drives the display array according to the initial values.

The present invention further provides an integrated display module. The integrated display module comprises an interface device, a storage device, a display array, and a drive unit. The interface device serves as a medium for the integrated display module to communicate with an external MPU interface and an external RGB interface. The storage device stores initial values required as the integrated display module operates, and the initial values are written before the integrated display module begins operating. The drive unit drives the display array according to the initial values.

A detailed description is given in the following embodiments with reference to the accompanying drawings.

### BRIEF DESCRIPTION OF THE DRAWINGS

Various aspects of the present invention can be more fully understood by reading the subsequent detailed description and examples with references made to the accompanying drawings, wherein:

FIG. 1 is a schematic diagram of a first integrated display module of the present invention.

FIG. 2 is a schematic diagram of another integrated display module of the present invention.

### DETAILED DESCRIPTION OF THE INVENTION

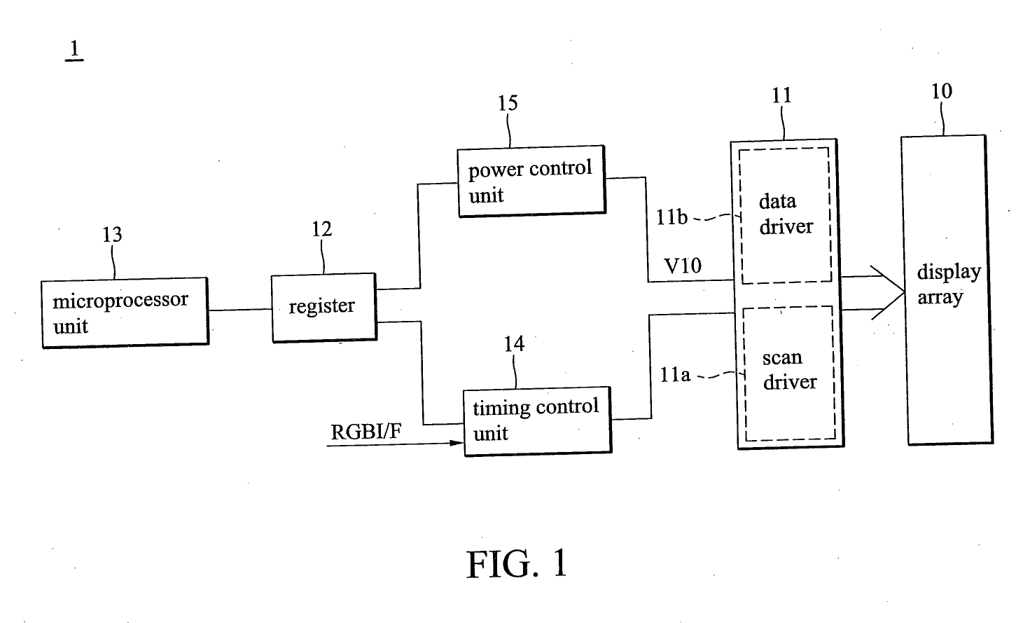

FIG. 1 is a schematic diagram of a first integrated display module of the present invention. The integrated display module 1 comprises a liquid crystal display array 10, a liquid crystal drive unit 11, a register 12, a microprocessor unit 13, a timing control unit 14, and a power control unit 15.

The liquid crystal display array 10 comprises a plurality of cells formed by interlaced data lines and scan lines. The liquid crystal drive unit 11 comprises a scan driver 11a and a data driver 11b. When receiving a scan control signal from the timing control unit 14, the scan driver 11a outputs a scan signal to drive one scan line. When receiving a data control signal from the timing control unit 14, the data driver 11b outputs a plurality of video signals respectively to the data lines simultaneously. An operating voltage V10 of the liquid crystal drive unit 11 is supplied from the power control unit 15.

When the integrated display module 1 begins operating, initial values of the integrated display module 1 are output by the microprocessor unit 13 to be stored in the register 12. The timing control unit 14 and the power control unit 15, coupled to the register 12, operate in accordance with the initial values. Further, the display characteristics of the liquid crystal display array 10 are determined according to the initial values.

When the integrated display module 1 begins operating, the microprocessor unit 13 automatically outputs the initial values to configure the timing control unit 14 and the power control unit 15, thus eliminating an additional manual setting process. According to the integrated display module 1, image data can be transmitted to the timing control unit 14 through the RGB interface (RGB I/F) for displaying images, and initial values of the integrated display module 1 can be configured automatically by microprocessor unit 13.

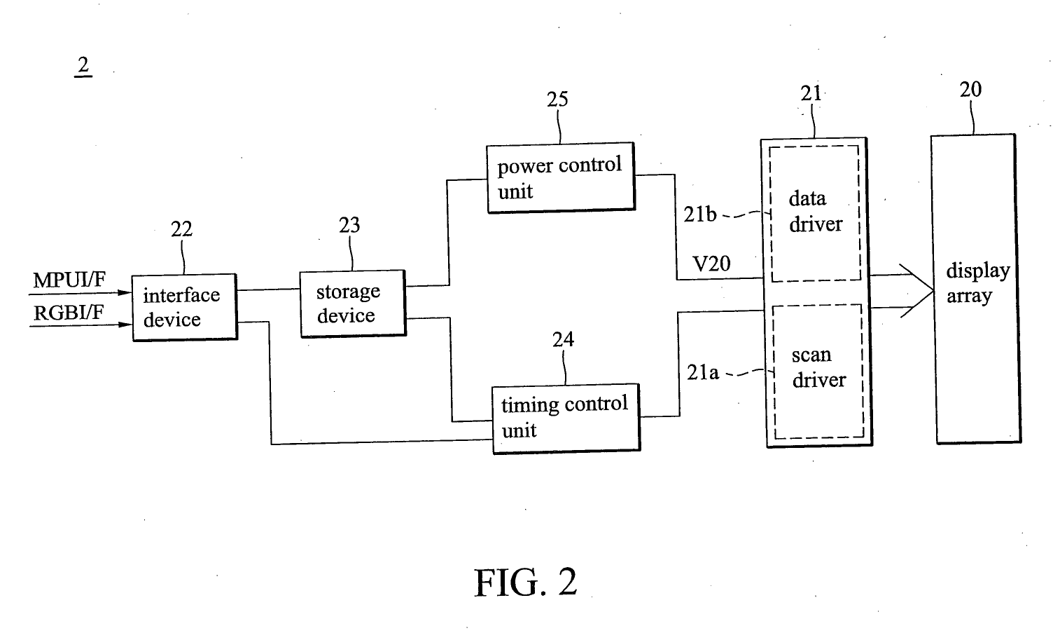

FIG. 2 is a schematic diagram of another integrated display module of the present invention. The integrated display module 2 comprises a liquid crystal display array 20, a liquid crystal drive unit 21, an interface device 22, a storage device 23, a timing control unit 24, and a power control unit 25. The storage device 23 can be a flash ROM or a EEPROM.

The liquid crystal display array 20 comprises a plurality of cells formed by interlaced data lines and scan lines. The liquid crystal drive unit 21 comprises a scan driver 21a and a data driver 21b. When receiving a scan control signal from the timing control unit 24, the scan driver 21a outputs a scan signal to drive one scan line. When receiving a data control signal from the timing control unit 24, the data driver 21b outputs a plurality of video signals respectively to the data lines simultaneously. An operating voltage V20 of the liquid crystal drive unit 21 is supplied from the power control unit 25. The storage device 23 stores initial values of the integrated display module 2. When the integrated display module 2 begins operating, the timing control unit 24 and the power control unit 25, coupled to the storage device 23, operate in accordance with the initial values. Further, the display characteristics of the liquid crystal display array 20 are determined according to the initial values.

The interface device 22 is a medium for the integrated display module 2 to communicate with an external MPU interface (MPU I/F) and an external RGB interface (RGB I/F). Image data is transmitted to the timing control unit 24 through the RGB interface (RGB I/F) for displaying images, and the initial values of the integrated display module 2 are obtained from the storage device 23. The initial values of the storage device 23 can be reconfigured manually via MPU interface (MPU I/F). Additionally, the image data can be transmitted through the MPU interface (MPU I/F).

As described above, the integrated display module operates in accordance with the initial values pre-stored in the storage device or the register. Manual configuration of the initial values is not required as the integrated display module begins operating. Moreover, the interface device provides a medium for the integrated display module to communicate with an external MPU interface and an external RGB interface. According to system requirements, the initial values stored in the storage device can be reconfigured through the MPU interface, and image data can be transmitted through the MPU interface or the RGB interface.

While the invention has been described by way of example, it is to be understood that the invention is not limited to the disclosed embodiments. To the contrary, it is intended that various modifications and similar arrangements (as would be apparent to those skilled in the art) be covered.

1. An integrated display module comprising:
a register storing required setting values as the integrated display module operates;
a microprocessor unit coupled to the register and writing initial values to the register when the integrated display module begins operating;
a display array displaying images; and
a drive unit driving the display array according to the initial values.

2. The integrated display module as claimed in claim 1 further comprising:
a timing control unit coupled to the register and controlling the drive unit; and
a power control unit coupled to the register and providing a first voltage to the drive unit, wherein the timing control unit and the power control unit operate in accordance with the initial values.

3. The integrated display module as claimed in claim 2, wherein the drive unit comprises:
a scan driver outputting a scan signal to scan lines of the display array sequentially according to a scan control signal from the timing control unit; and
a data driver outputting video signals to corresponding data lines of the display array according to a data control signal from the timing control unit.

4. An integrated display module comprising:
an interface device serving as a medium for the integrated display module to communicate with an external MPU interface and an external RGB interface;
a storage device storing initial values required as the integrated display module operates, wherein the initial values are written before the integrated display module begins operating.
a display array displaying images; and
a drive unit driving the display array according to the initial values.

5. The integrated display module as claimed in claim 4 further comprising:
a timing control unit coupled to the storage device and controlling the drive unit; and
a power control unit coupled to the storage device and providing a first voltage to the drive unit, wherein the timing control unit and the power control unit operate in accordance with the initial value.

6. The integrated display module as claimed in claim 5, wherein the drive unit comprises:
a scan driver outputting a scan signal to scan lines of the display array sequentially according to a scan control signal from the timing control unit; and
a data driver outputting video signals to corresponding data lines of the display array according to a data control signal from the timing control unit.

7. The integrated display module as claimed in claim 4, wherein the storage device is a flash ROM.

8. The integrated display module as claimed in claim 4, wherein the storage device is an EEPROM.

9. The integrated display module as claimed in claim 4, wherein the initial values are modified through the external MPU interface.
